(19) United States
(12) Patent Application Publication
(10) Pub. No.: US 2017/0320751 A1
(43) Pub. Date: Nov. 9, 2017

(54) Particle Separation in Method for Recovering Magnetite from Bauxite Residue

(71) Applicant: GMR, LLC, Worcester, MA (US)

(72) Inventor: Mohsen Amiran, DesPlaines, IL (US)

(21) Appl. No.: 15/604,181

(22) Filed: May 24, 2017

Related U.S. Application Data
(63) Continuation of application No. PCT/US2015/062383, filed on Nov. 24, 2015.
(60) Provisional application No. 62/083,549, filed on Nov. 24, 2014.

(51) Int. Cl. C01G 49/08

(52) U.S. Cl. CPC C01G 49/08

(57) ABSTRACT

A method of recovering magnetite from bauxite residue, comprising reducing the pH of the bauxite residue to form a treated bauxite residue, drying the treated bauxite residue, adding to and mixing into the treated bauxite residue a solid source of carbon, to create a mixture, heating the mixture to a reduction temperature of at least 800° C. in a reducing reactor to produce a reduced bauxite residue in which a major portion of Fe₂O₃ present in the treated bauxite residue has been converted to Fe₃O₄, exposing the reduced bauxite residue to a particle separation step, and then separating the reduced bauxite residue into an iron-enriched portion and an iron-depleted portion.

### CROSS-REFERENCE TO RELATED APPLICATIONS

This application is a continuation of and claims priority of PCT/US2015/062383, filed on Nov. 24, 2015, which itself claimed priority of Ser. No. 62/083,549, filed on Nov. 24, 2014.

### FIELD

This disclosure relates to treating bauxite residue.

### BACKGROUND

The Bayer process, invented in 1887 by Karl Bayer, is used throughout the world to produce aluminum from bauxite. A by-product of the process is the production of un-dissolved bauxite residue which is red in color and is commonly called Red Mud. More than 80 aluminum refinery plants around the world produce approximately 1.5 tons of tailings for each 4 tons of bauxite processed in the manufacture of 1 ton of aluminum. The global industry generates over 80 million dry metric tons of tailings each year which are stored in bauxite residue ponds and behind dams.

Red Mud is highly caustic with a pH value of about 13. The high pH is due to the use of sodium hydroxide to extract aluminum oxide from the bauxite. Despite a longstanding recognition by the aluminum industry of the disadvantages associated with residue storage, it has nevertheless continued to be the preferred solution considering economic, environmental, and social factors. As of 2007, stored bauxite residue totaled 2.7 billion tons with residues projected to reach 4 billion tons by 2015.

A number of potential options for re-use of bauxite residues have been suggested. Some of these are:
neutralizing treatment material for acidic mining wastes
material for construction purposes (e. g., road fill, brick making)
source of raw materials for ceramics
feedstock for mineral production (e.g., pig iron).

None of these is widely used as evidenced by the estimated 3 billion tons of bauxite residue currently in storage. No viable process for the use of bauxite residue as a feedstock for the production of mineral and metal values has ever been implemented to date.

As noted above, Red Mud is characterized by an alkaline pH of 12-13. Red Mud particle sizes tend to be very small, the particle size distribution being such that about 20 to 40% of the particles will have a diameter of less than 1 micrometer, about 60% will have a diameter between 1 and 10 micrometers and the median particle size is around 4-5 microns. Although the solids content of Red Mud varies depending on how long and under what conditions it has been stored, the solids content generally ranges from 60 to 70%, with the principal chemical compounds in Red Mud being:
20 to 50% (or more) Fe₂O₃
17 to 26% Al₂O₃
6 to 12% TiO₂
7 to 20% SiO₂
5 to 12% Na₂O
7 to 8% CaO

The majority of the solid material in Red Mud is a mixture of Fe₂O₃ and Al₂O₃. Both of these compounds have similar crystalline structures which are described as rhombohedral, that is, the structures are a parallelepiped whose faces are rhombuses. The similarity in crystalline structure of these two compounds results in interactions which make it difficult to separate the two minerals economically.

### SUMMARY

The presently disclosed methods utilize both physical and chemical processes by which the Fe₂O₃ (iron oxide) contained in Red Mud is converted to synthetic Fe₃O₄ (magnetite), and thereafter separated for recovery and reuse. The methods, when executed in accord with the disclosed steps, are capable of extracting 80 to 90% of the iron (Fe) in the Red Mud. The form of the iron, synthetic magnetite, is a black powder-like material that is widely used as a pigment in industrial manufacturing applications including high-temperature composite materials, coatings, acrylic and oil-based paints, plastics, and other polymer resins, as well as being used in adding color to various types of metallic surfaces.

Disclosed herein and discussed in more detail below are methods of recovering magnetite from bauxite residue including reducing the pH of the bauxite residue to form a treated bauxite residue, drying the treated bauxite residue, heating the treated bauxite residue to a reduction temperature while applying a reducing fluid to produce a reduced bauxite residue in which a major portion of Fe₂O₃ present in the treated bauxite residue has been converted to Fe₃O₄; and separating the reduced bauxite residue into an iron-enriched portion containing Fe₃O₄ and/or Fe and an iron-depleted portion.

As will be appreciated by those skilled in the art, the basic the methods of recovering magnetite from bauxite residue may include other steps and sub-steps depending on the composition of the starting material, the equipment and feed streams available. For example, some embodiments of the disclosed methods may include cooling the reduced bauxite residue under a non-oxidizing environment before separating the Fe₃O₄, combining a quantity of coke with the treated bauxite residue and generating at least a portion of the reducing fluid by decomposing a portion of the coke to form carbon monoxide.

Other examples of the disclosed methods may include combining a volume of carbon dioxide with the carbon monoxide to form a reducing fluid having a CO/CO₂ ratio of, for example, 1:1 to 2:1. Again, depending on the particular process conditions, other CO/CO₂ ratios may be sufficient for suppressing further reduction of the Fe₃O₄ in the reduced bauxite residue, thereby increasing the yield of magnetite in preference to elemental iron. The reduction reaction can be conducted under a variety of conditions, again depending on the equipment and feed streams available, but a reduction temperature of 700° F. to 1100° F., and preferably at least 800° F., are expected to provide satisfactory results.

The residual portion of the Red Mud after the magnetite has been removed can be subjected to additional processing to recover other metals and/or metallic compounds including, for example, aluminum, aluminum compounds, titanium, and titanium compounds. And, despite a preference for a CO/CO₂ reducing atmosphere, other reduction agents may be used with or instead of the preferred composition including, for example, NO_{N}, N₂, NH₃, H₂ and mixtures thereof.

With respect to the drying operation, the goal is to produce a treated bauxite residue that comprises predominately particulates through which the reducing fluid can pass readily in order to contact and interact with the Fe₂O₃ within the Red Mud. As will be appreciated by those skilled in the art, a variety of drying techniques and equipment may be utilized to achieve this goal of reducing the moisture content of the treated bauxite residue to something on the order of 3% to 6%. Other unit operations include, for example, milling, screening and agitating, in order to obtain an appropriate particle size distribution within the treated bauxite residue.

Although it is expected that in most instances magnetite will be the target iron-rich product, in some cases there may be a need or a preference for elemental iron. In such instances, the composition of the reducing fluid(s) and the reduction temperature may be adjusted to promote more complete reduction of the Fe₂O₃ and/or Fe₃O₄. Such modifications may include, for example, increasing the duration of the reduction processing, using a more aggressive reducing agent, and/or reducing the content of reduction reaction suppressing components including, for example, CO₂, to increase the reduction rate and/or completion percentage.

This disclosure features a method of recovering magnetite from bauxite residue that has a pH, comprising reducing the pH of the bauxite residue to form a treated bauxite residue, drying the treated bauxite residue, adding to and mixing into the treated bauxite residue a solid source of carbon, to create a mixture, heating the mixture to a reduction temperature of at least 800° C. in a reducing reactor to produce a reduced bauxite residue in which a major portion of Fe₂O₃ present in the treated bauxite residue has been converted to Fe₃O₄, exposing the reduced bauxite residue to a particle separation step, and then separating the reduced bauxite residue into an iron-enriched portion and an iron-depleted portion. The method may further include cooling the reduced bauxite residue under a non-oxidizing environment before the separating step.

The solid source of carbon may comprise coke. A portion of the coke may be decomposed in the reducing reactor to form carbon monoxide. The method may further comprise combining a volume of carbon dioxide with the carbon monoxide to form a reducing fluid having a CO/CO₂ ratio. The CO/CO₂ ratio may be from 1:1 to 2:1. The CO/CO₂ ratio may be sufficient to suppress reduction of the Fe₃O₄ in the reduced bauxite residue.

The method may further include injecting into the reducing reactor a volume of carbon dioxide and a volume of carbon monoxide to form a reducing fluid having a CO/CO₂ ratio. The CO/CO₂ ratio may be sufficient to suppress reduction of Fe₃O₄ in the reduced bauxite residue. The reducing fluid may be applied while the treated bauxite residue is heated to a reduction temperature of up to 1100° C. The method may further comprise processing the iron-depleted portion to recover at least one of aluminum, aluminum compounds, titanium, and titanium compounds. The treated bauxite residue may have a moisture content of 3% to 6% by weight after drying. The particle separation step may comprise impacting the reduced bauxite residue with a high-pressure water stream.

Also featured is a method of recovering magnetite from bauxite residue that has a pH, comprising reducing the pH of the bauxite residue to a pH in the range of 4-9, to faun a treated bauxite residue, drying the treated bauxite residue to from 3% to 6% moisture by weight, adding to and mixing into the dried treated bauxite residue coke, to create a mixture, wherein the coke comprise from 30% to 60% by weight of the mixture, heating the mixture to a reduction temperature of from 800° C. to 1100° C. in a reducing reactor to produce a reduced bauxite residue in which a major portion of Fe₂O₃ present in the treated bauxite residue has been converted to Fe₃O₄, exposing the reduced bauxite residue to a particle separation step and then magnetically separating the Fe₃O₄ from the reduced bauxite residue, to create an iron-enriched portion and an iron-depleted portion. The particle separation step may comprise impacting the reduced bauxite residue with a high-pressure water stream.

### BRIEF DESCRIPTION OF THE DRAWINGS

FIG. 1 illustrates a process flow comprising a first embodiment of the disclosed method.

FIG. 2 illustrates a process flow comprising a second embodiment of the disclosed method.

FIG. 3 illustrates a process flow comprising a third embodiment of the disclosed method.

FIG. 4 is a schematic view of an example of a particle separator that can be used in the subject disclosure.

It should be noted that these Figures are intended to illustrate general characteristics of the disclosed methods and to supplement the written description provided below. As will be appreciated by those skilled in the art, therefore, these drawings do not in all cases reflect the structural or logical arrangement of the unit operations and equipment that could used to practice the disclosed methods and, accordingly, should not be interpreted as unduly defining or limiting the following claims.

Indeed, it is well within the skill of one of ordinary skill in the art guided by this disclosure to design a plant, with all of the necessary auxiliary equipment and materials, for practicing the disclosed methods. Similarly, it is well within the skill of one of ordinary skill in the art to modify and/or adjust the parameters of the disclosed methods in order to compensate for variations in materials, equipment and/or process goals.

### DETAILED DESCRIPTION

The present disclosure takes advantage of the very fine particles of Fe₂O₃ in the Red Mud by using CO as one example of a reducing agent, the CO being supplied either directly as a gas or, in another embodiment, generated from low VOC coke or a different solid source of carbon. Reduction takes place while heating the mixture. Reduction can occur in the presence of CO₂ and at a temperature sufficient to reduce the Fe₂O₃. Typically, a reducing temperature greater than 800° F. will be sufficient to initiate and achieve substantial completion of the reduction process that changes the Fe₂O₃ to Fe₃O₄. The primary chemical reaction to be utilized is represented in Reaction [1]:

3 Fe₂O₃+CO=>2 Fe₃O₄+CO₂ [1]

although one or more additional reduction reactions can be utilized at the operator's discretion including, for example, those reactions illustrated in Reactions [2]-[4]:

Fe₂O₃+3 H₂=>2 Fe+3 H₂O [2]

Fe₃O₄+4 CO=>3 Fe+4 CO₂ [3]

3 Fe₂O₃+H₂=>2 Fe₃O₄+H₂O [4]

As will be appreciated by those skilled in the art, other reducing agents such as NH₃ or H₂, either singly or in combination (e.g., forming gas) with or without one or more nitrogen compounds could accomplish the reduction. Carbon monoxide is preferred over these reducing agents, however, for providing improved control of the reaction and/or increased safety. Using hydrogen and/or ammonia, for example, tends to introduce additional safety considerations and increases the likelihood that these reducing agents would also tend to reduce at least a portion of the desired magnetite, Fe₃O₄, to elemental iron.

Of particular interest, at the reducing temperature the crystalline form of Fe₂O₃, which is rhombohedral, is converted to the crystalline form of Fe₃O₄, which is cubic. It is believed that this morphological change from rhombohedral to cubic makes possible the physical separation of Fe₃O₄ from Al₂O₃, Reducing temperatures below 800° F. are generally less preferred both because the reduction reaction will tend to be incomplete and because the severing of the bonds between the Fe₃O₄and AlO₂ components of the Red Mud will not tend to be as complete.

Depending on factors including, for example, the particular goals for the treatment, the composition of the Red Mud being treated and the market for the various products that can be recovered from the Red Mud, the basic production processes, as illustrated in the figures, may be modified through the addition or adjustment of a number of major steps, each of which may, in turn, consist of several sub steps.

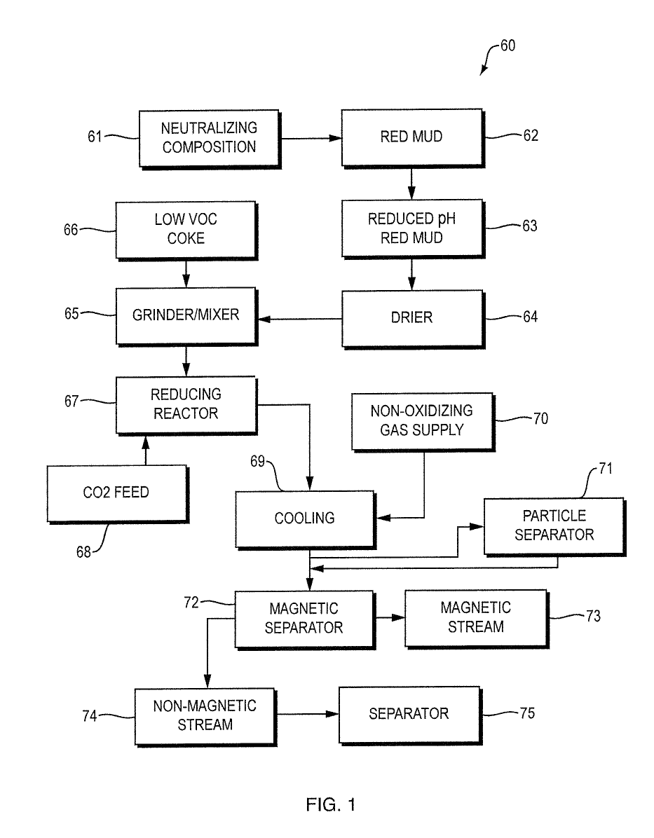

Process 60, FIG. 1, will typically begin by using an acidic catalyst plus neutralizing solution 61, for example, a concentrated aqueous phosphoric acid solution (54% P₂O₅) to treat the Red Mud 62. Although other mineral acids such as HCl could accomplish the buffering, such use would, for example, release chlorine which could cause a dangerous condition, and are, consequently, less preferred. Organic acids could also be used. The catalyst plus neutralizing solution is used to reduce the pH of the Red Mud from its typical range of 12-13 into a range of about 4-9, preferably about 7.

The neutralized Red Mud 63 is then dried 64, preferably to a moisture content range of 3 to 6%. The drying operation may use, for example, a preheated column operating at a temperature of, for example, 100 to 200° F., with the heat supplied by any combination of off gases, onsite cogenerated electricity or heat, or other recovered sources of heat and/or energy. The drying operation may also be conducted under a partial vacuum to increase the drying rate.

At this point in the process, if CO is to be the reducing agent of choice, the means of delivering the CO to the treated bauxite residue may be selected from a number of options. In a preferred method, CO gas is injected as discussed infra. Alternatively, coke, preferably low VOC coke 66 (<10% VOC and <5% ash), may be used to supply CO. If coke is selected as the CO source, a sufficient volume of coke is added to and mixed into the Red Mud such that the coke comprises 30 to 60% by weight of the resulting Red Mud/coke mixture. The Red Mud/coke mixture is then pulverized using, for example, one or more mechanical grinders 65 to ensure a homogeneous mixture and achieve a target particle size range within the mixture. It is preferred, for example, that the maximum particle size of the pulverized Red Mud/coke mixture be around 150 μm. Although smaller particle sizes could certainly be acceptable, and would be expected improve the yield and/or rate of the reduction reaction, achieving the smaller particle size range would also tend to increase the processing costs significantly. Accordingly, the preparation of particle size ranges substantially less than 150 μm is feasible, but it is expected that in most instances such additional processing would not be deemed cost effective.

The treated and dried Red Mud mixture or, alternatively, the pulverized Red Mud/Coke mixture, may be fed into a reducing reactor 67 comprising, for example, a rotary kiln, operating at a reduction temperature of 700 to 1100° F. In a preferred embodiment, as the treated and dried Red Mud material flows through the kiln, a sufficient volume of a CO/CO₂ mixture is injected in a counter flow direction such that atmospheric oxygen in the kiln is purged so that a less oxidizing atmosphere, and preferably a substantially non-oxidizing atmosphere is established and maintained within the reducing reactor during the reduction operation.

In the CO/CO₂ mixture, the CO₂ acts as an “inert” gas to suppress or reduce the oxidation rate of the Fe₂O₃ contained in the material while the CO acts as the primary reducing agent. Other “inert” gasses could be considered including, for example, N₂, Ne, He or Ar. However, these alternative gases are less preferred than CO₂ because, for example, under the conditions within the reducing reactor N₂ can be oxidized to NOₓ, a corrosive and a pollutant while Ar and other noble gases are generally considered to be too expensive for cost-effective use. It is also believed that the addition of CO₂ also acts to slow down the interaction of CO to reduce the Fe₂O₃ and form Fe₃O₄ while suppressing further reduction of the Fe₃O₄, thereby increasing the yield of Fe₃O₄.

It is believed that a CO/CO₂ ratio of between 1:1 and 2:1 will generally achieve acceptable reduction results, but factors including, for example, the Red Mud composition, the reactor design, and the reducing temperature may dictate use of CO/CO₂ ratios outside the preferred range in order to achieve better results. If coke is being used to supply CO for the reduction, it is preferred that a sufficient volume of CO₂ be injected 68 into the reducing reactor to achieve both the oxidation suppression and reduction tempering functions.

As the reduced Red Mud composition exits the reducing reactor, it will typically be cooled 69 in preparation for further processing. A preferred method of cooling is to pass the reduced Red Mud material through a heat exchanger that will allow for recovery of some of the excess heat added in the kiln. At least during the initial period of cooling, it is also preferred that the reduced Red Mud material be maintained under a substantially non-oxidizing atmosphere (e.g., using non-oxidizing gas supply 70) to suppress reversion of the Fe₃O₄. The heat removed in this step may be utilized either in the drying step or alternatively used to cogenerate electricity that may be used to power the kiln and/or other equipment and thereby reduce the overall operating cost of the plant. Alternatively, the cooling may be achieved by simply holding the mixture at ambient temperature for a sufficient period of time.

After cooling, the synthetic Fe₃O₄ magnetite may be separated from the mixture using a magnetic separator 72 to separate an iron-rich product stream. The synthetic Fe₃O₄ magnetite flow stream 73 exiting the magnetic separator may then be directed to an air classifier or other particle separator device(s). Classification may be performed because particles smaller than 100 nm, nano-scale magnetite, typically comprise about 10 to 15% of the total Fe₃O₄ and there are separate, higher value markets for this nano-scale magnetite. Indeed, the market price for the smaller particles tends to be several times greater than the market price for those particles that are larger than 100 nanometers so effective separation can improve the economics of the overall process. Those particles larger than 100 nanometers, typically comprising about 85 to 90% of the Fe₃O₄ generated, are collected for sale, and use as pigment. In the event that there is no particular interest in selling the smaller particles separately, or if the classification process is uneconomical, this additional separation may be eliminated and the smaller particles can remain in a mixture with the large particles.

The non-magnetic particle flow stream 74 exiting from the magnetic separator can be subjected to additional processing as well. For example, the non-magnetic particle flow stream may be combined with water or other carrier liquid or composition to form a slurry that is, in turn, processed through multiple gravity separation steps that separate the particles according to their densities. It is estimated, for example, that titanium dioxide can be separated with a purity of 70-80%, followed by aluminum oxide with a purity of 50-60%.

A wide range of separation equipment suitable for use in this step is well known to those of ordinary skill in the art and may include, for example, spiral concentrators, centrifuges, or a combination of the two as well as other equipment depending on the physical composition of the feed stream. The recovered titanium dioxide and aluminum oxide are sold for reuse. The remaining residue may be further processed for the recovery of other valuable metals, or optionally segregated and disposed as a waste.

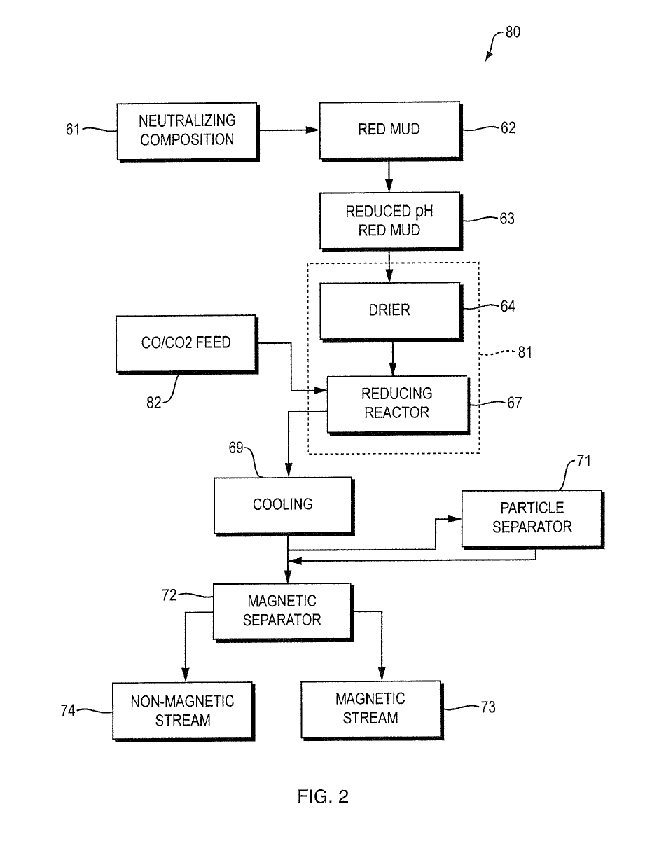

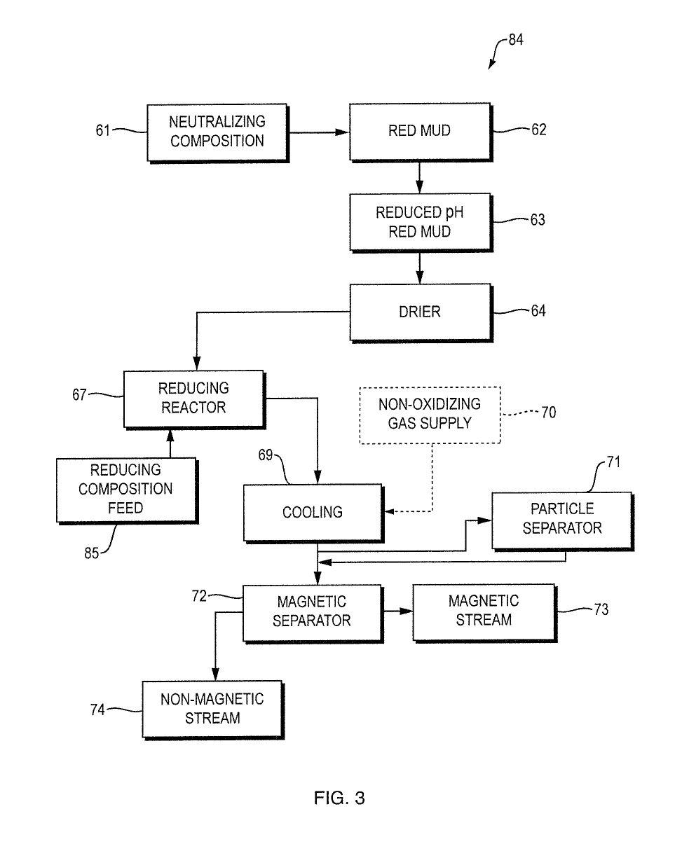

In process 80, FIG. 2, the drying step 64 and the reducing step 67 take place within flow-through reactor 81, with the reducing fluid (a CO/CO₂ mixture 82) supplied to reactor 81. Process 84, FIG. 3, illustrates the feed 85 of a reducing composition such as described herein, to reducing reactor 67 (along with the dried, neutralized red mud).

Currently, un-dissolved bauxite residue, Red Mud, is stored indefinitely in holding ponds or behind dams at aluminum refineries throughout the world. Despite ongoing efforts by the aluminum industry and researchers to develop uses for the residue, no use has been found that is feasible, scalable to accommodate large volumes, economic, and acceptable to the public. The method detailed herein provides the following advantages:

The present disclosure applies chemical reduction theory well-known in the art to a problematic waste product, Red Mud, to produce a high value product, synthetic Fe₃O₄ pigment, and it utilizes existing industrial equipment to derive further value from the non-magnetic component of the processed Red Mud to produce/separate other high value products. The methods are easily scalable for accommodating the high volumes of bauxite residue currently being generated. Further, because the disclosed methods utilize processes based on proven chemical theory, they can be achieved using conventional equipment and can be achieved without generating any particularly problematic waste products. It is expected that plants operating in accord with the disclosed processes should be acceptable to both the public and governmental regulators and not present any significant environmental or other regulatory concerns.

It has been found that the reduced red mud composition that exits the reducing reactor can agglomerate; the particles can be loosely fused or stuck together. If non-magnetic particles are stuck to magnetic particles when the material is magnetically separated, non-magnetic particles will be separated from the stream. The purity of the magnetite can thus be compromised. Also, the amount of other (non-magnetite) fractions will be reduced accordingly. Without being bound to any particular theory of the reason for the agglomeration, it is believed that the elevated temperatures of the reactor can cause mono-valent cations to become hydrated. Hydrated compounds can stick together more than non-hydrated compounds due to ionic attraction.

Accordingly, purity and yield can be increased by subjecting the material exiting the reactor to a particle separation process 71. This option can be included in all of the examples discussed herein or falling under the scope of the invention. Any presently known or future developed particle separation process that is compatible with the materials can be used. As one non-limiting example, the material can be passed through a device that uses high pressure liquid jets and/or high-speed mixing to disrupt the attractive bonds between particles so as to separate them. The device will typically but not necessarily use water, but potentially could use a different liquid.

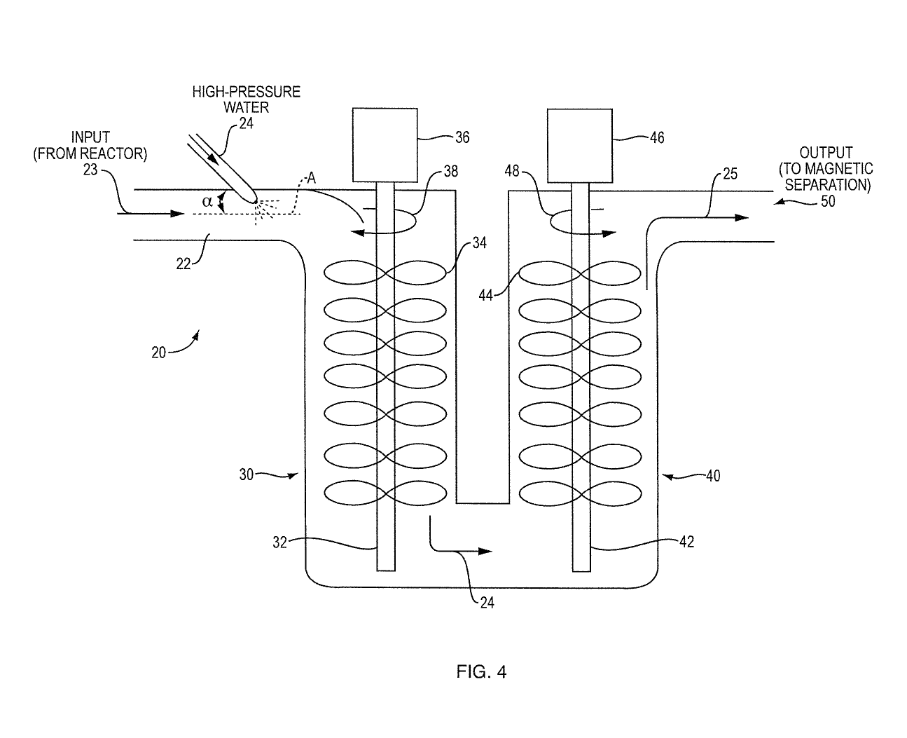

A non-limiting example of a particle separation device 20 is shown in FIG. 4. Device 20 is a flow-through device with inlet 22 and outlet 50. Material to be separated flows in the direction of arrows 23-25. High-pressure water (e.g., at 5,000 to 10,000 psi) is sprayed into the particle stream through spray nozzle 24. Nozzle 24 may be pointed at or close to the longitudinal axis “A” of inlet 22, typically at an angle α to axis A of from about 30 to about 60 degrees. The energy imparted to the particle flow helps to break up agglomerated particles and separate them into individual particles, each of which consists only of magnetic or non-magnetic compounds. The mixed flow can then be subjected to one or more high-speed mixing operations; two such unit operations 30 and 40 are illustrated but there may be one, or more than two. Each consists of a high-speed motor 36 and 46 (e.g., running at 500-1500 RPM) and a shaft 32, 42 carrying mixing blades 34, 44. The direction of rotation (38, 48) helps to move the mixture along in the direction of arrows 24 and 25. Flow from exit 50 can then be passed directly into a magnetic separation unit operation.

As one non-limiting specific example of device 20, the material flow can be at about 10 metric tons (tonne) per hour. Water flow through nozzle 24 can be about 20 gallons per minute. Mixers 30 and 40 can each be about 3 feet in diameter and 6-8 feet high.

Non-limiting alternative particle separation techniques include grinding, milling, tumbling and other known mechanical processes that are designed to decrease the particle size of solid materials or slurries. Another example that can be used when the reactor product is carried by a liquid would be cavitation. For example, the liquid could be forced through a constriction such as a venturi and expanded so as to promote cavitation. The forces created by cavitation can contribute to particle separation.

Particle separation should take place before magnetic separation, as shown in FIG. 1. In some cases, in order to increase the yield of magnetite, multiple separate magnetic separation steps can be utilized in the process. In this case, particle separation preferably takes place before the first magnetic separation step, but it could take place before any or all of multiple magnetic separation steps.

While the present invention has been described with reference to preferred embodiments, various changes or substitutions may be made on these methods by those ordinarily skilled in the art without departing from the scope of the present invention. Therefore, the scope of the present invention encompasses not only those embodiments described above, but all those that fall within the scope of the claims provided below.

What is claimed is:

1. A method of recovering magnetite from bauxite residue that has a pH, comprising:
reducing the pH of the bauxite residue to form a treated bauxite residue;
drying the treated bauxite residue;
adding to and mixing into the treated bauxite residue a solid source of carbon, to create a mixture;
heating the mixture to a reduction temperature of at least 800° C. in a reducing reactor to produce a reduced bauxite residue in which a major portion of Fe₂O₃ present in the treated bauxite residue has been converted to Fe₃O₄;
exposing the reduced bauxite residue to a particle separation step; and then
separating the reduced bauxite residue into an iron-enriched portion and an iron-depleted portion.

2. The method of recovering magnetite from bauxite residue according to claim 1, further comprising: cooling the reduced bauxite residue under a non-oxidizing environment before the separating step.

3. The method of recovering magnetite from bauxite residue according to claim 1, wherein the solid source of carbon comprises coke.

4. The method of recovering magnetite from bauxite residue according to claim 3, wherein a portion of the coke is decomposed in the reducing reactor to form carbon monoxide.

5. The method of recovering magnetite from bauxite residue according to claim 4, further comprising combining a volume of carbon dioxide with the carbon monoxide to foal' a reducing fluid having a CO/CO₂ ratio.

6. The method of recovering magnetite from bauxite residue according to claim 5, wherein the CO/CO₂ ratio is from 1:1 to 2:1.

7. The method of recovering magnetite from bauxite residue according to claim 5, wherein the CO/CO₂ ratio is sufficient to suppress reduction of the Fe₃O₄ in the reduced bauxite residue.

8. The method of recovering magnetite from bauxite residue according to claim 1, further comprising injecting into the reducing reactor a volume of carbon dioxide and a volume of carbon monoxide to form a reducing fluid having a CO/CO₂ ratio.

9. The method of recovering magnetite from bauxite residue according to claim 8, wherein the CO/CO₂ ratio is sufficient to suppress reduction of Fe₃O₄ in the reduced bauxite residue.

10. The method of recovering magnetite from bauxite residue according to claim 8, wherein the reducing fluid is applied while the treated bauxite residue is heated to a reduction temperature of up to 1100° C.

11. The method of recovering magnetite from bauxite residue according to claim 1, further comprising processing the iron-depleted portion to recover at least one of aluminum, aluminum compounds, titanium, and titanium compounds.

12. The method of recovering magnetite from bauxite residue according to claim 1, wherein the treated bauxite residue has a moisture content of 3% to 6% by weight after drying.

13. The method of recovering magnetite from bauxite residue according to claim 1, wherein the particle separation step comprises impacting the reduced bauxite residue with a high-pressure water stream.

14. A method of recovering magnetite from bauxite residue that has a pH, comprising:
reducing the pH of the bauxite residue to a pH in the range of 4-9, to form a treated bauxite residue;
drying the treated bauxite residue to from 3% to 6% moisture by weight;
adding to and mixing into the dried treated bauxite residue coke, to create a mixture, wherein the coke comprises from 30% to 60% by weight of the mixture;
heating the mixture to a reduction temperature of from 800° C. to 1100° C. in a reducing reactor to produce a reduced bauxite residue in which a major portion of Fe₂O₃ present in the treated bauxite residue has been converted to Fe₃O₄;
exposing the reduced bauxite residue to a particle separation step; and then
magnetically separating the Fe₃O₄ from the reduced bauxite residue, to create an iron-enriched portion and an iron-depleted portion.

15. The method of recovering magnetite from bauxite residue according to claim 14, wherein the particle separation step comprises impacting the reduced bauxite residue with a high-pressure water stream.
